(19) United States
(12) Patent Application Publication
(10) Pub. No.: US 2010/0158299 A1
(43) Pub. Date: Jun. 24, 2010

(54) POSITION AND DIRECTIONALITY ADJUSTABLE MULTI-RANGE SURROUND-SOUND SPEAKER CABINET

(76) Inventor: Chun I LIU, Taoyuan City (TW)

Correspondence Address: Guice Patents PLLC, 12647 Galveston Court #302, Manassas, VA, 20112, US

(21) Appl. No.: 12/337,840

(22) Filed: Dec. 18, 2008

(51) Int. Cl. H04R 1/02

(52) U.S. Cl. 381/333; 381/334

(57) ABSTRACT

A position and directionality adjustable multi-range surround-sound speaker cabinet includes an elongated three-dimensional main body and a mounting bracket unit. A plurality of speakers is mounted at predetermined positions on front, rear, bottom, and two lateral sides of the main body. The mounting bracket unit includes a left and a right mounting bracket connected near to left and right ends of the bottom side of the main body, such that the main body is movably supported on and connected to the mounting bracket unit and can be adjusted to different elevation angles for changing sound wave transmission and directionality. And, the sound wave transmission can be changed or adjusted according to room size to obtain the most suitable surrounding sound effect.

### FIELD OF THE INVENTION

The present invention relates to a multi-range surround-sound speaker cabinet, and more particularly to a position and directionality adjustable multi-range surround-sound speaker cabinet, which includes a main body having a plurality of speakers mounted thereon to orient to different directions and being movably supported on a mounting bracket unit to allow adjustment in elevation angle of the main body.

### BACKGROUND OF THE INVENTION

Following the quick progress in the electronic technological field, most of the currently available electronic apparatus, particularly electronic entertainment apparatus, such as televisions (TVs), movie houses, and stereo systems, have digitalized hardware and program production and playback. The monitors for TVs and computers are also developed from the traditional cathode ray tube (CRT) screen to the liquid crystal display (LCD) and plasma display panel (PDP). The LCD TV and PDP TV are high-tech products to provide planar imaging effect that is obviously better than the imaging effect provided by the screen of traditional CRT TV. The LCD and PDP have the advantages of showing bright colors and clear images, having small volume and light weight, and being low power consumption and low heat generation.

However, most of the currently available LCD TVs have speakers directly mounted in the TV at two lateral sides or at a lower front of the TV. These speakers are immovable and can only transmit sound waves in a fixed direction. A user is not allowed to freely change the orientation of the speakers according to different room size in order to obtain the best possible sound field effect. Therefore, the user could not enjoy good sound effect when watching TV, and the TV fails to satisfy the user's requirement in listening enjoyment.

Compared to the progress and development in TV imaging technique, the TV audio technique is apparently insufficient without significant development and has a lot of disadvantages and limits in terms of sound reproduction. Therefore, it is desirable to make more improvements in the current TV audio technique.

### SUMMARY OF THE INVENTION

A primary object of the present invention is to provide a position and directionality adjustable multi-range surround-sound speaker cabinet, with which it is able to change the transmission and directionality of sound waves, and a user can change and adjust the sound wave transmission according to different room size to obtain a surrounding sound effect most suitable for the user's room size.

To achieve the above and other objects, the position and directionality adjustable multi-range surround-sound speaker cabinet according to the present invention includes an elongated three-dimensional main body and a mounting bracket unit. A plurality of speakers is mounted at predetermined positions on front, rear, bottom, and two lateral sides of the main body. The mounting bracket unit includes a left and a right mounting bracket connected near to left and right ends of the bottom side of the main body, such that the main body is movably supported on and connected to the mounting bracket unit and can be adjusted to different elevation angles. With these arrangements, the main body can resonate with room floor and room space at different angular positions and from different distances to thereby achieve different changes in sound field and the best possible surrounding sound effect.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a position and directionality adjustable multi-range surround-sound speaker cabinet according to a preferred embodiment of the present invention;

FIG. 2 shows the position and directionality adjustable multi-range surround-sound speaker cabinet of FIG. 1 with screens mounted thereto;

FIG. 3 shows the position and directionality adjustable multi-range surround-sound speaker cabinet of FIG. 2 mounted to a top of an LCD TV;

FIG. 4 is a fragmentary side view of FIG. 3;

FIG. 5 is a side view similar to FIG. 4 showing the position and directionality adjustable multi-range surround-sound speaker cabinet of FIG. 4 can be adjusted to different elevation angles;

FIG. 6 is a perspective view showing the position and directionality adjustable multi-range surround-sound speaker cabinet of FIG. 1 with a suspension bracket unit connected to a rear side thereof; and

FIG. 7 is a side view showing the position and directionality adjustable multi-range surround-sound speaker cabinet of FIG. 6 is mounted on a wall surface with adjustable inclination angle.

### DETAILED DESCRIPTION OF THE PREFERRED EMBODIMENTS

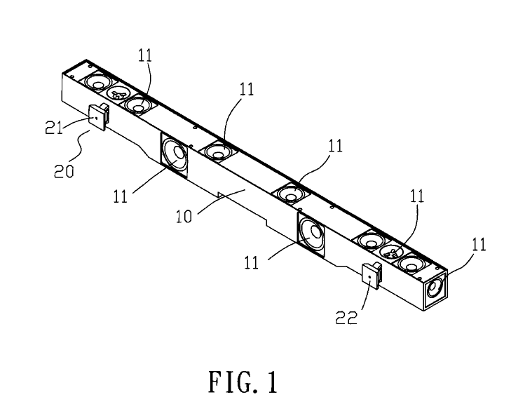

Please refer to FIG. 1 that is a perspective view of a position and directionality adjustable multi-range surround-sound speaker cabinet according to a preferred embodiment of the present invention. As shown, the present invention includes a main body 10 and a mounting bracket unit 20.

The main body 10 is in the form of an elongated three-dimensional enclosure. A plurality of speakers 11 is mounted at selected positions on front, rear, bottom, and two lateral sides of the main body 10. The number and position of the speakers 11 can be determined according to a user's requirement for sound transmission and different types of speaker cabinets.

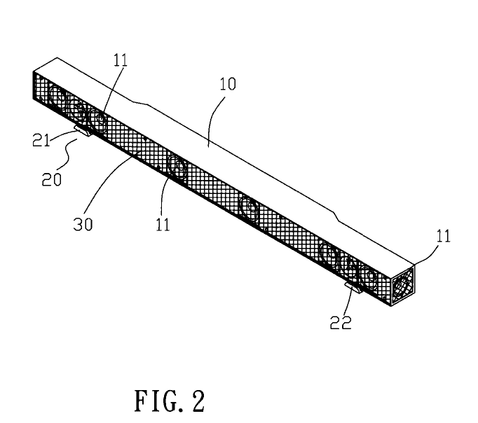

As can be seen from FIG. 2, screens 30 can be covered on the main body 10 to create an esthetic and integral appearance for the speaker cabinet while providing a dust-proof effect.

The mounting bracket unit 20 includes a left and a right mounting bracket 21, 22 respectively connected near to a left and a right end of the bottom side of the main body 10, such that the main body 10 is movably supported on the mounting bracket unit 20 and can be adjusted to different elevation angles.

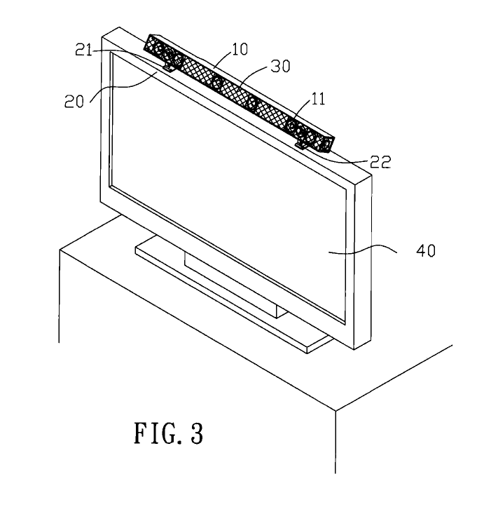

Please refer to FIG. 3. As an example, the left and right mounting brackets 21, 22 of the mounting bracket unit 20 can be stably fixed at respective bottoms to a top of an LCD TV 40 with double-sided adhesive tapes, adhesive, or screws (not shown), so that the multi-range surround-sound speaker cabinet of the present invention can be mounted to the top of the LCD TV 40 without the risk of falling easily. Alternatively, as per the user's preference or requirement, the multi-range surround-sound speaker cabinet can be positioned in front of the LCD TV, on a floor in front of the LCD TV, or at any other appropriate place. Then, the main body 10 of the speaker cabinet can be adjusted to a suitable elevation angle according to an actual height in position of the speaker cabinet, so as to create the best possible sound field effect.

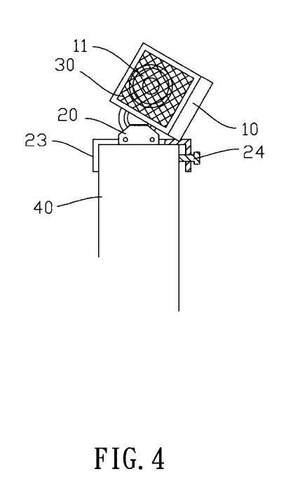

In an operable embodiment of the present invention shown in FIG. 4, the left and right mounting brackets 21, 22 of the mounting bracket unit 20 each can have a substantially n-shaped seat 23 with two downward bent leg portions. By fitting the n-shaped seats 23 on the top of the LCD TV 40 and extending screws 24 through the leg portions to tighten the n-shaped seats 23 against the LCD TV 40, the mounting brackets 21, 22 can stably straddle the top of the LCD TV 40 and be locked thereto.

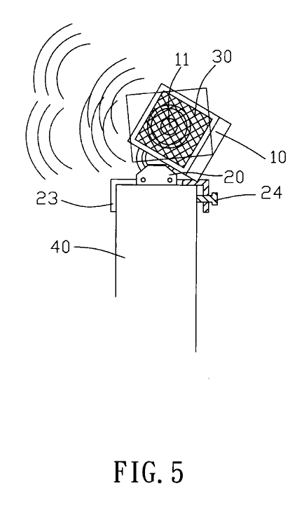

As can be seen from FIG. 5, the main body 10 is connected to and supported on the mounting bracket unit 20 to form an adjustable speaker cabinet for the LCD TV 40. When watching a picture on the LCD TV 40, the main body 10 of the multi-range surround-sound speaker cabinet can be adjusted to different elevation angles relative to the mounting bracket unit 20, so that the main body 10 can resonate with and room floor and room space at different angular positions and from different distances, enabling change and adjustment of sound wave transmission from the main body 10. The user can automatically adjust the sound field according to the room size, so as to obtain the surround sound effect most suitable for the existing room space.

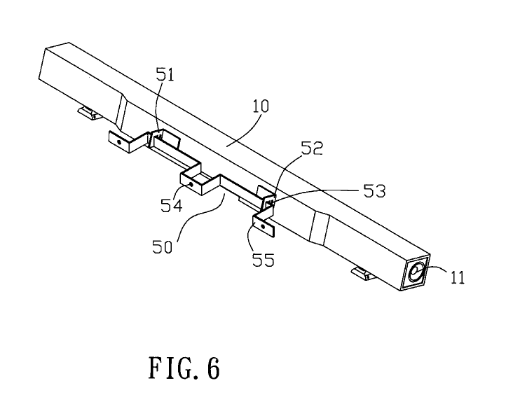

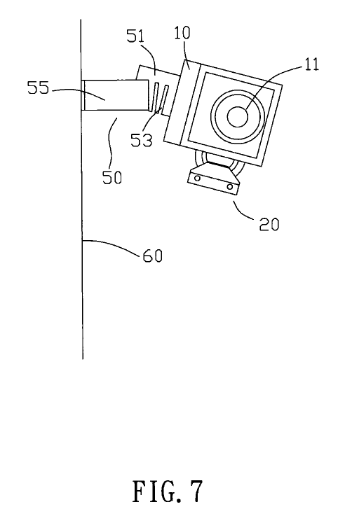

In a further embodiment of the present invention shown in FIGS. 6 and 7, a suspension bracket unit 50 is further provided to the rear side of the main body 10.

The suspension bracket unit 50 includes a set of two spaced L-shaped hooking brackets 51, 52 connected to the rear side of the main body 10 to face each other and having a plurality of slots 53 with different extending angles, and a particularly bent wall-mount bracket 55 provided with mounting holes 54 for mounting to a wall surface 60. Therefore, instead of being mounted on the LCD TV, the main body 10 can be otherwise mounted on a wall surface 60 at a desired position simply by engaging two corresponding slots 53 on the two hooking brackets 51, 52 with the wall-mount bracket 55. In this manner, the user can also change the sound field to obtain the best possible sound-surround ambience.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A position and directionality adjustable multi-range surround-sound speaker cabinet, comprising:
a main body being an elongated three-dimensional enclosure, and having a plurality of speakers mounted thereon at predetermined positions to orient to different directions; and
a mounting bracket unit including a left and a right mounting bracket respectively connected near to a left and a right end of a bottom side of the main body, so that the main body is movably supported on and connected to the mounting bracket unit.

2. The position and directionality adjustable multi-range surround-sound speaker cabinet as claimed in claim 1, wherein the speakers are mounted on front, rear, bottom, and two lateral sides of the main body.

3. The position and directionality adjustable multi-range surround-sound speaker cabinet as claimed in claim 2, wherein the main body is covered with screens.

4. The position and directionality adjustable multi-range surround-sound speaker cabinet as claimed in claim 3, wherein the mounting bracket unit has a bottom attached to the LCD TV by means selected from the group consisting of double-sided tapes and fastening screws.

5. The position and directionality adjustable multi-range surround-sound speaker cabinet as claimed in claim 3, wherein each of the left and the right mounting bracket has a substantially n-shaped seat with two downward extended leg portions, and the n-shaped seat can straddle the LCD TV and be stably tightened thereto by screws extended through the leg portions against the LCD TV.

6. The position and directionality adjustable multi-range surround-sound speaker cabinet as claimed in claim 3, further comprising a suspension bracket unit provided to the rear side of the main body; the suspension bracket unit including a set of two spaced L-shaped hooking brackets and a particularly bent wall-mount bracket; the L-shaped hooking brackets being connected to the rear side of the main body to face each other, and being correspondingly provided at predetermined positions with a plurality of slots having different extending angles; the bent wall-mount bracket being provided with mounting holes for mounting to a wall surface; whereby, by selecting and engaging two corresponding slots on the two hooking brackets with the bent wall-mount bracket, the main body can be mounted to a wall surface and adjusted to different inclination angles.
